(19) United States
(12) Patent Application Publication
(10) Pub. No.: US 2023/0387444 A1
(43) Pub. Date: Nov. 30, 2023

(54) FUEL CELL UNIT

(71) Applicant: TOYOTA JIDOSHA KABUSHIKI KAISHA, Toyota-shi (JP)

(72) Inventors: Yoshihiro SHINOZAKI, Atsugi-shi (JP); Toshiaki KUSAKARI, Sunto-gun (JP); Masaaki MATSUSUE, Mishima-shi (JP)

(21) Appl. No.: 18/187,736

(22) Filed: Mar. 22, 2023

(30) Foreign Application Priority Data
May 26, 2022 (JP) 2022-085945

(51) Int. Cl. H01M 8/2485; B60L 50/70

(52) U.S. Cl. CPC H01M 8/2485; B60L 50/70; H01M 2250/20

(57) ABSTRACT

In a plan view of the fuel cell unit viewed from an auxiliary device side, an area surrounded by an outer edge of a first auxiliary device is referred to as an area A, an area surrounded by an outer edge of a fuel cell stack is referred to as an area B 1, an area surrounded by an outer edge of a power converter is referred to as an area B2, and an area obtained by adding the area B1 and the area B2 together is referred to as an area B3. The area A overlaps at least part of the area B1 and at least part of the area B2. An entirety of the area A is included inside the area B3.

### CROSS-REFERENCE TO RELATED APPLICATION

This application claims priority to Japanese Patent Application No. 2022-085945 filed on May 26, 2022, incorporated herein by reference in its entirety.

### BACKGROUND

### 1. Technical Field

The present disclosure relates to a fuel cell unit.

### 2. Description of Related Art

A fuel cell is a cell that generates electrical energy through a chemical reaction between an oxygen-containing oxidant gas and a hydrogen-containing fuel gas. A cell (single cell) that is a basic unit of a fuel cell (fuel cell stack) usually includes a membrane electrode assembly (MEA) in which electrode catalyst layers are formed on the opposite surfaces of a solid polymer electrolyte membrane. A gas diffusion layer (GDL) is disposed outside the MEA. A separator provided with a gas flow path is disposed outside the gas diffusion layer.

The fuel cell unit includes at least a fuel cell stack and a power converter. In addition, the fuel cell unit usually includes an auxiliary device that assists the operation of the fuel cell. For example, in the fuel cell unit disclosed in Japanese Unexamined Patent Application Publication No. 2017-135093 (JP 2017-135093 A), a converter with reactors being substantially parallel to the stacking direction of the single cells is disposed above or below the fuel cell stack.

### SUMMARY

When the fuel cell unit is mounted on, for example, a fuel cell electric vehicle (FCEV), it is preferable that the fuel cell unit has good mountability (installability). The present disclosure provides a fuel cell unit with good mountability.

A fuel cell unit according to the present disclosure includes a fuel cell stack, a power converter configured to convert electric power of the fuel cell stack, and at least a first auxiliary device as an auxiliary device configured to assist operation of the fuel cell stack. The power converter is disposed on a first surface of the fuel cell stack. The auxiliary device is connected to a second surface of the fuel cell stack via a stack manifold. A normal direction of the first surface and a normal direction of the second surface intersect. In a plan view of the fuel cell unit viewed from the auxiliary device side, an area surrounded by an outer edge of the first auxiliary device is referred to as an area A, an area surrounded by an outer edge of the fuel cell stack is referred to as an area B1, an area surrounded by an outer edge of the power converter is referred to as an area B2, and an area obtained by adding the area B1 and the area B2 together is referred to as an area B3. The area A overlaps at least part of the area B1 and at least part of the area B2, and an entirety of the area A is included inside the area B3.

The fuel cell unit may include a second auxiliary device as the auxiliary device. In the plan view, when an area surrounded by an outer edge of the second auxiliary device is referred to as an area C, an entirety of the area C may be included inside either the area B1 or the area B2.

The fuel cell unit may not be provided with, as the auxiliary device, an auxiliary device protruding from the area B3.

The first auxiliary device may be at least one of a gas-liquid separator, a humidifier, or an ejector.

The fuel cell unit may be provided with, as the power converter, a converter and an inverter. The converter and the inverter may be disposed in this order from the first surface side.

In the fuel cell unit, proportion of a portion of the area A that overlaps the area B1 to the entirety of the area A may be 50% or more.

In the fuel cell unit, proportion of a portion of the area A that overlaps the area B2 to the entirety of the area A may be 50% or more.

The present disclosure has the effect of being able to provide a fuel cell unit with good mountability.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic plan view of a fuel cell unit according to the present disclosure, viewed from an auxiliary device side in plan;

FIG. 1B is a schematic plan view of the fuel cell unit according to the present disclosure, viewed from the right-left direction of the drawing sheet of FIG. 1A;

FIG. 2A is a schematic plan view of a fuel cell unit of a comparative example, viewed from an auxiliary device side in plan;

FIG. 2B is a schematic plan view of the fuel cell unit of the comparative example, viewed from the right-left direction of the drawing sheet of FIG. 2A;

FIG. 3 is a schematic plan view illustrating the fuel cell unit according to the present disclosure;

FIG. 4 is a schematic plan view illustrating the fuel cell unit according to the present disclosure;

FIG. 5A is a schematic plan view illustrating the fuel cell unit according to the present disclosure;

FIG. 5B is a schematic plan view illustrating the fuel cell unit according to the present disclosure;

FIG. 6A is a schematic sectional view illustrating a fuel cell stack according to the present disclosure;

FIG. 6B is a schematic sectional view illustrating a single cell according to the present disclosure;

FIG. 7A is a schematic plan view illustrating the fuel cell unit according to the present disclosure; and

FIG. 7B is a schematic plan view illustrating the fuel cell unit according to the present disclosure.

### DETAILED DESCRIPTION OF EMBODIMENTS

A fuel cell unit according to the present disclosure will be described in detail below. Each figure shown below is schematically shown, and the size and shape of each part are appropriately exaggerated for easy understanding. In the present specification, when expressing a mode in which, with respect to a certain member, another member is disposed, simply describing “above” or “below” includes, unless otherwise specified, both a case where the other member is disposed directly above or directly below the certain member in such a manner that the other member is in contact with the certain member and a case where the other member is disposed above or below the certain member with a different member in between.

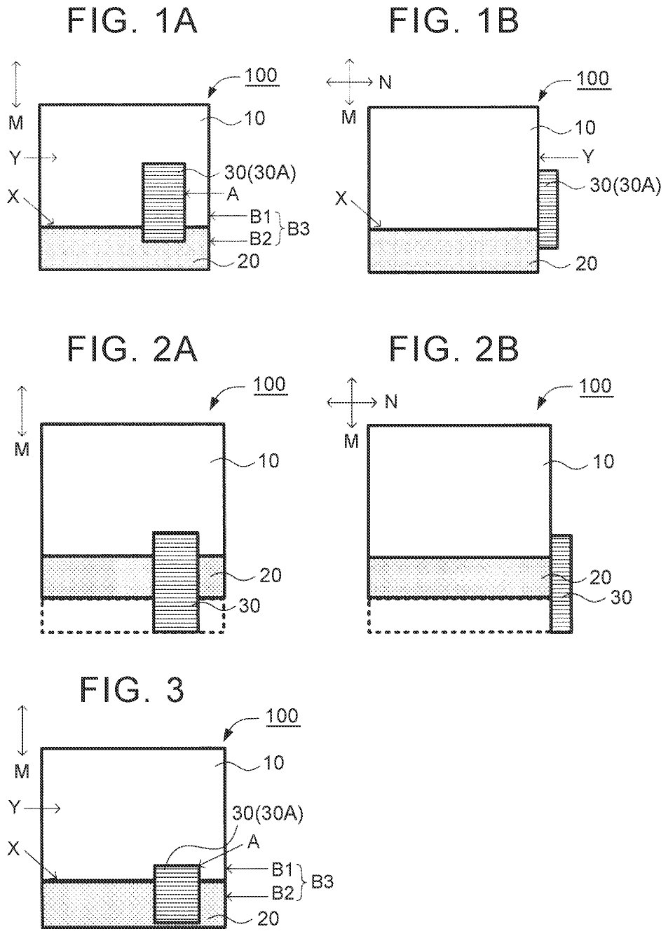

FIG. 1A and FIG. 1B are schematic plan views illustrating the fuel cell unit according to the present disclosure. FIG. 1A is a plan view of the fuel cell unit viewed from an auxiliary device side in plan. FIG. 1B is a plan view of the fuel cell unit viewed from the right-left direction of the drawing sheet of FIG. 1A. As shown in FIG. 1A and FIG. 1B, the fuel cell unit 100 includes a fuel cell stack 10, a power converter 20 that converts electric power of the fuel cell stack 10, and an auxiliary device 30 that assists the operation of the fuel cell stack 10. Further, as shown in FIG. 1A and FIG. 1B, the power converter 20 is disposed on a first surface X of the fuel cell stack 10. The auxiliary device 30 is connected to a second surface Y of the fuel cell stack 10 via a stack manifold (not shown). As shown in FIG. 1B, the normal direction M of the first surface X and the normal direction N of the second surface Y intersect. The fuel cell unit 100 includes, as the auxiliary device 30, a first auxiliary device 30A. Further, as shown in FIG. 1A, in a plan view of the fuel cell unit 100 viewed from the auxiliary device 30 side, when an area surrounded by the outer edge of the first auxiliary device 30A is referred to as an area A, an area surrounded by the outer edge of the fuel cell stack 10 is referred to as an area B1, an area surrounded by the outer edge of the power converter 20 is referred to as an area B2, and an area obtained by adding the area B1 and the area B2 together is referred to as an area B3, the area A overlaps at least part of the area B1 and at least part of the area B2, and the entirety of the area A is included inside the area B3.

According to the present disclosure, in a plan view of the fuel cell unit 100 viewed from the auxiliary device 30 side, the area A surrounded by the outer edge of the first auxiliary device 30A overlaps at least part of the area B1 surrounded by the outer edge of the fuel cell stack 10 and at least part of the area B2 surrounded by the outer edge of the power converter 20, and the entirety of the area A is included inside the area B3 that is obtained by adding the area B1 and the area B2 together. Therefore, the fuel cell unit 100 can have good mountability.

The effect of the fuel cell stack 10 according to the present disclosure will be described using FIG. 2A and FIG. 2B. FIG. 2A is a plan view corresponding to FIG. 1A, and FIG. 2B is a plan view corresponding to FIG. 1B. As shown in FIG. 2A and FIG. 2B, when the auxiliary device 30 protrudes from the fuel cell stack 10 and the power converter 20, an extra space for mounting the fuel cell stack is needed for the area surrounded by the dotted lines in the figure. Therefore, the mountability deteriorates. On the other hand, in the fuel cell unit according to the present disclosure, as shown in FIG. 1A, the entirety of the area A surrounded by the outer edge of the first auxiliary device 30A is included inside the area B3 that is obtained by adding the area B1 surrounded by the outer edge of the fuel cell stack 10 and the area B2 surrounded by the outer edge of the power converter 20 together. Therefore, the mountability of the fuel cell unit 100 can be improved.

Here, the fuel cell stack 10 and the power converter 20 are usually housed in a fuel cell case and a power converter case, respectively. Therefore, in the present disclosure, the area B1 can be regarded as an area surrounded by the outer edge of the fuel cell case. Similarly, the area B2 can be regarded as an area surrounded by the outer edge of the power converter case. Also, in the present disclosure, “inside” an area includes the outer edge portion of the area.

As shown in FIG. 1A and FIG. 1B, the power converter 20 in the present disclosure is disposed on the first surface X of fuel cell stack 10. The normal direction M of the first surface X may be parallel to the stacking direction D (FIG. 6A) of the fuel cell (single cell) described later, or may be orthogonal to the stacking direction D of the single cell. Moreover, the first surface X of the fuel cell stack 10 is preferably the lower surface of the fuel cell stack 10 in the direction of gravity. In the present disclosure, being “parallel” includes not only being strictly parallel but also a case where the angle formed by two directions is 10° or less. The angle may be 5° or less. In the present disclosure, being “orthogonal” includes not only being strictly orthogonal but also a case where the angle formed by two directions is 80° or more and 100° or less. The angle may be 85° or more and 95° or less.

As shown in FIG. 1A and FIG. 1B, the auxiliary device 30 in the present disclosure is connected to the second surface Y of the fuel cell stack 10. The normal direction N of the second surface Y may be parallel to the stacking direction D of the fuel cell (single cell) described later, or may be orthogonal to the stacking direction D of the single cell. Being “parallel” and being “orthogonal” are as described above. Further, the normal direction M of the first surface X and the normal direction N of the second surface Y intersect. The normal direction M and the normal direction N may or may not be orthogonal, but are preferably orthogonal. Being “orthogonal” is as described above.

The fuel cell unit 100 in the present disclosure includes, as the auxiliary device 30, the first auxiliary device 30A. As to the first auxiliary device 30A, the area A overlaps at least part of the area B1 and at least part of the area B2. For example, as shown in FIG. 1A, the proportion of the portion of the area A that overlaps the area B1 to the entirety of the area A may be 50% or more. Meanwhile, as shown in FIG. 3, the proportion of the portion of the area A that overlaps the area B2 to the entirety of the area A may be 50% or more. Moreover, the proportion of the portion of the area B1 that overlaps the area A to the entirety of the area B1 is, for example, 5% or more, and may be 10% or more. Meanwhile, the proportion of the portion of the area B1 that overlaps the area A to the entirety of the area B1 is 100% or less, and may be 70% or less, or may be 50% or less. The proportion of the portion of the area B2 that overlaps the area A to the entirety of the area B2 is the same as that of the area B1.

As to the first auxiliary device 30A in the present disclosure, the entirety of the area A is included inside the area B3. The proportion of the portion of the area B3 that overlaps the area A to the entirety of the area B3 is, for example, 5% or more, and may be 10% or more, or may be 30% or more. Meanwhile, the proportion of the portion of the area B3 that overlaps the area A to the entirety of the area B3 is, for example, 90% or less, and may be 70% or less, or may be 50% or less.

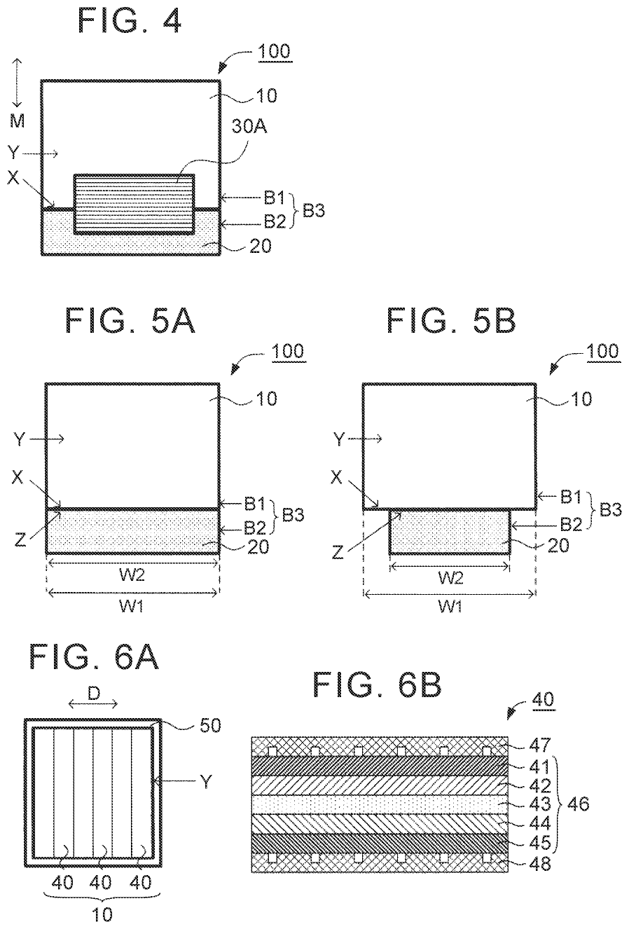

Further, as shown in FIG. 1A, the first auxiliary device 30A may extend in the normal direction M of the first surface X of the fuel cell stack 10 in the plan view. Meanwhile, as shown in FIG. 4, the first auxiliary device 30A may extend in the direction intersecting with the normal direction M of the first surface X of the fuel cell stack 10 in the plan view. The intersection may or may not be orthogonal. Being orthogonal is as described above. In the plan view, the shape of the first auxiliary device 30A (the planar shape of the area A) may be a rectangular shape such as a square and a rectangle, a polygonal shape such as a triangle, a circular shape such as a circle and an ellipse, or a combination of the polygonal shape and the circular shape. The “polygonal shape” includes not only a strict polygon, but also a shape in which a portion corresponding to the corner of the polygon is formed in an arc shape.

FIG. 5A and FIG. 5B are schematic plan views illustrating the fuel cell unit 100 according to the present disclosure, viewing the fuel cell unit 100 from the auxiliary device (not shown) side in plan. As shown in FIG. 5A, in the fuel cell unit 100, the width W1 of the area B1 and the width W2 of the area B2 may be the same. Meanwhile, as shown in FIG. 5B, in the fuel cell unit 100, the width W1 of the area B1 and the width W2 of the area B2 may be different. “The same” means that W2/W1, which will be described later, is or more and 1.05 or less. When the width W1 and the width W2 are different, the ratio of W2 to W1 (W2/W1) is, for example, 0.5 or more, and may be 0.7 or more, or may be 0.9 or more. Meanwhile, W2/W1 is, for example, 1.2 or less. Here, the “width W1” refers to the length of the first surface X of the fuel cell stack 10 when the fuel cell unit 100 is viewed from the auxiliary device side in plan, as shown in FIG. 5A and FIG. 5B. The “width W2” refers to the length of a surface Z of the power converter 20 that faces the first surface X of the fuel cell stack 10 when the fuel cell unit 100 is viewed from the auxiliary device side in plan.

As shown in FIG. 5A and FIG. 5B, the shape (planar shape) of the area B1 and the area B2 may each be a quadrilateral. The “quadrilateral” includes not only a strict quadrilateral, but also a shape in which a portion corresponding to the corner of the quadrilateral is formed in an arc shape. Further, the planar shape of the area B3 may be a quadrilateral as shown in FIG. 5A, or may be a protruding shape as shown in FIG. 5B. The “protruding shape” includes not only a strict protruding shape as shown in FIG. 5B, but also a shape in which a portion corresponding to the corner of the protruding shape is formed in an arc shape.

### 1. Fuel Cell Stack

FIG. 6A and FIG. 6B are schematic sectional views illustrating the fuel cell stack 10 and the fuel cell (single cell 40) according to the present disclosure. As shown in FIG. 6A, the fuel cell stack 10 in the present disclosure usually has a stack structure in which multiple single cells 40 are stacked. The number of single cells 40 (the number of stacks) is usually two or more, and may be five or more, or may be 10 or more. As described above, the stacking direction D of the single cells 40 may be parallel or may be orthogonal to the normal direction M of the first surface X of the fuel cell stack 10 shown in FIG. 1A and the like. The stacking direction D of the single cells 40 may be parallel or may be orthogonal to the normal direction N of the second surface Y of the fuel cell stack 10 shown in FIG. 1B and the like. As shown in FIG. 6A, the surface of the fuel cell stack 10 at the end of the stacking direction D of the single cells 40 is preferably the second surface Y.

As shown in FIG. 6A, the fuel cell stack 10 in the present disclosure is usually housed in a fuel cell case 50. The fuel cell case 50 is usually provided with an opening for electrically connecting the fuel cell stack 10 (FIG. 1A, etc.) and the power converter 20 (FIG. 1A, etc.). The material of the fuel cell case 50 is not particularly limited, and various materials can be used.

The shape of the fuel cell stack 10 is preferably a shape of a rectangular parallelepiped as a whole. The “shape of the rectangular parallelepiped” includes not only a strict rectangular parallelepiped but also a shape that can approximate the shape of the rectangular parallelepiped. Note that the shape of the fuel cell stack 10 can also be regarded as the shape of the fuel cell case 50.

As shown in FIG. 6B, the fuel cell (single cell) 40 includes a membrane electrode assembly (MEA) 46 in which a cathode-side gas diffusion layer 41, a cathode catalyst layer 42, an electrolyte membrane 43, an anode catalyst layer 44, and an anode-side gas diffusion layer 45 are stacked in this order, and two separators 47, 48 sandwiching the MEA 46.

Examples of the electrolyte membrane 43 include a fluorine-based electrolyte membrane such as a perfluorosulfonic acid membrane and a non-fluorine-based electrolyte membrane. Examples of the non-fluorine-based electrolyte membrane include a hydrocarbon-based electrolyte membrane. The thickness of the electrolyte membrane 43 is, for example, 5 μm or more and 100 μm or less.

The cathode catalyst layer 42 and the anode catalyst layer 44 include, for example, a catalyst metal that promotes an electrochemical reaction, a base material that supports the catalyst metal, an electrolyte with proton conductivity, and carbon particles with electron conductivity. Examples of the catalyst metal include simple metals such as platinum (Pt) and ruthenium (Ru), and alloys containing Pt. Examples of the electrolyte include fluorine-based resins. Examples of the base material and an electrically conductive material include carbon materials such as carbon. The thicknesses of the cathode catalyst layer 42 and the anode catalyst layer 44 are each, for example, 5 μm or more and 100 μm or less.

The anode-side gas diffusion layer 45 and the cathode-side gas diffusion layer 41 may be electroconductive members having gas permeability. Examples of the electroconductive member include porous carbon bodies such as carbon cloth and carbon paper, and porous metal bodies such as metal mesh and metal foam. The thicknesses of the anode-side gas diffusion layer 45 and the cathode-side gas diffusion layer 41 are each, for example, 5 μm or more and 100 μm or less.

The separator 47 may have a gas path on the surface facing the cathode-side gas diffusion layer 41. The separator 48 may have a gas path on the surface facing the anode-side gas diffusion layer 45. Examples of materials of the separators 47, 48 include metal materials such as stainless steel, and carbon materials such as carbon composite materials. The separators 47, 48 have electron conductivity and also function as current collectors for generated electricity.

### 2. Power Converter

The position of the power converter 20 in the present disclosure is as described above. Also, the power converter 20 in the present disclosure is usually housed in a power converter case. The power converter case is usually provided with an opening for electrically connecting the fuel cell stack 10 and the power converter 20. The material of the power converter case is not particularly limited, and various materials can be used.

The power converter 20 is not particularly limited as long as it is a member that converts the electric power of the fuel cell stack 10. The power converter 20 may be a converter such as a step-up converter, a step-down converter, a buck-boost converter capable of both stepping up and stepping down voltages, or an inverter that converts direct current power into alternating current power. Further, the fuel cell unit 100 may have one type of the above devices as the power converter 20, or may have two or more types of the above devices as the power converter 20. For example, when the fuel cell unit 100 has a converter and an inverter as the power converter 20, it is preferable that the converter and the inverter are disposed in this order from the first surface X side. Electricity generated by the fuel cell stack can flow to the converter and the inverter without being detoured, and the mountability of the fuel cell unit 100 is improved.

### 3. Auxiliary Device

The auxiliary device 30 in the present disclosure is connected to the fuel cell stack 10 via the stack manifold. The fuel cell unit 100 in the present disclosure includes, as the auxiliary device 30, at least the first auxiliary device 30A. The positions of the auxiliary device 30 and the first auxiliary device 30A are as described above. The stack manifold is a piping component that supplies the fuel cell stack 10 with, for example, oxidant gas, fuel gas, and coolant. The shape and material of the stack manifold are not particularly limited and can be adjusted as appropriate.

Although the type of the first auxiliary device 30A is not particularly limited, examples thereof include devices related to water circulation of the fuel cell stack 10, such as a gas-liquid separator, a humidifier, and an ejector. Further, the fuel cell unit 100 may have only one first auxiliary device 30A, or may have two or more first auxiliary devices

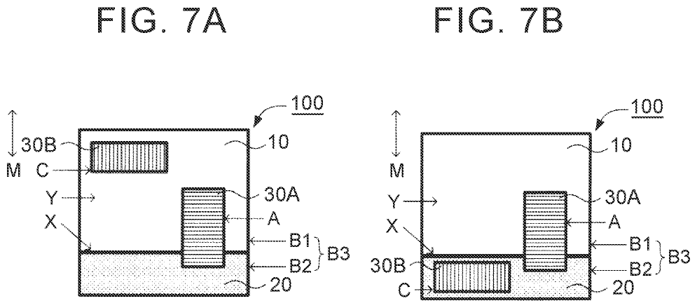

The fuel cell unit 100 in the present disclosure may include, as the auxiliary device 30, a second auxiliary device 30B. As shown in FIG. 7A and FIG. 7B, in the plan view, the entirety of the area C surrounded by the outer edge of the second auxiliary device is included inside either the area B1 or the area B2 that are described above. As shown in FIG. 7A, the entirety of the area C may be included inside the area B1. Meanwhile, as shown in FIG. 7B, the entirety of the area C may be included inside the area B2.

The shape of the second auxiliary device 30B and the direction of extension of the second auxiliary device 30B in the plan view can be the same as the shape and direction described for the first auxiliary device 30A.

Examples of the second auxiliary device 30B include devices related to water circulation of the fuel cell stack 10, such as a gas-liquid separator, a humidifier, and an ejector. Further, the fuel cell unit 100 may have only one second auxiliary device 30B, or may have two or more second auxiliary devices 30B.

It is preferable that the fuel cell unit 100 in the present disclosure does not have, as the auxiliary device 30, an auxiliary device 30 protruding from the area B3. The mountability of the fuel cell unit 100 is thereby improved.

### 4. Fuel Cell Unit

Applications of the fuel cell unit 100 according to the present disclosure include, for example, vehicles such as fuel cell electric vehicles (FCEVs). In addition, the fuel cell unit 100 according to the present disclosure may be used in moving bodies other than vehicles (for example, railways, ships, and aircraft), and may be used in an object other than moving bodies.

The present disclosure is not limited to the above embodiments. The above embodiments are illustrative, and anything having substantially the same configuration as, and having similar functions and effects to, the technical idea described in the claims of the present disclosure is included in the technical scope of the present disclosure.

What is claimed is:

1. A fuel cell unit comprising:
a fuel cell stack;
a power converter configured to convert electric power of the fuel cell stack; and
at least a first auxiliary device as an auxiliary device configured to assist operation of the fuel cell stack, wherein:
the power converter is disposed on a first surface of the fuel cell stack;
the auxiliary device is connected to a second surface of the fuel cell stack via a stack manifold;
a normal direction of the first surface and a normal direction of the second surface intersect; and
in a plan view of the fuel cell unit viewed from the auxiliary device side, when an area surrounded by an outer edge of the first auxiliary device is referred to as an area A, an area surrounded by an outer edge of the fuel cell stack is referred to as an area B1, an area surrounded by an outer edge of the power converter is referred to as an area B2, and an area obtained by adding the area B1 and the area B2 together is referred to as an area B3, the area A overlaps at least part of the area B1 and at least part of the area B2, and an entirety of the area A is included inside the area B3.

2. The fuel cell unit according to claim 1, further comprising a second auxiliary device as the auxiliary device, wherein in the plan view, when an area surrounded by an outer edge of the second auxiliary device is referred to as an area C, an entirety of the area C is included inside either the area B1 or the area B2.

3. The fuel cell unit according to claim 1, wherein the fuel cell unit is not provided with, as the auxiliary device, an auxiliary device protruding from the area B3.

4. The fuel cell unit according to claim 1, wherein the first auxiliary device is at least one of a gas-liquid separator, a humidifier, or an ejector. and

5. The fuel cell unit according to claim 1, wherein:
the fuel cell unit is provided with, as the power converter, a converter and an inverter;
the converter and the inverter are disposed in this order from the first surface side.

6. The fuel cell unit according to claim 1, wherein proportion of a portion of the area A that overlaps the area B1 to the entirety of the area A is 50% or more.

7. The fuel cell unit according to claim 1, wherein proportion of a portion of the area A that overlaps the area B2 to the entirety of the area A is 50% or more.
